(19) United States
(12) Patent Application Publication
(10) Pub. No.: US 2025/0209937 A1
(43) Pub. Date: Jun. 26, 2025

(54) TEETH MODEL

(71) Applicant: NISSIN DENTAL PRODUCTS INC., Kyoto (JP)

(72) Inventors: Saori MATSUMURA, Kameoka-shi (JP); Yumiko OUCHI, Kameoka-shi (JP)

(73) Assignee: NISSIN DENTAL PRODUCTS INC., Kyoto (JP)

(21) Appl. No.: 18/851,968

(22) PCT Filed: Mar. 28, 2022
(86) PCT No.: PCT/JP2022/014985

§ 371 Date: Sep. 27, 2024

(51) Int. Cl. G09B 23/28; A61C 13/34

(52) U.S. Cl. CPC G09B 23/283; A61C 13/34

(57) ABSTRACT

Provided is a teeth model which is easy for even a novice to explore, and with which it is possible to practice removal using a calculus removal tool. This teeth model 10 comprises a model tooth body 10A and model calculus 13 which is provided to a side surface 10a of the model tooth body 10A. The model calculus 13 includes a large model calculus 13B having a maximum width W1 of 0.7 mm≤W1≤1.5 mm in a planar view seen from a side of the side surface 10a, and having a boundary width W2 of W2<W1 which is a width at the boundary with the side surface 10a of the model tooth body 10A in the same direction as the direction of the maximum width W1.

### TECHNICAL FIELD

The present invention relates to a tooth model.

### BACKGROUND ART

Tooth models have been used in training for dental treatment. In recent years, as tooth models have become more prevalent in society, tooth models have also been used in training for removing calculi from a tooth (see Patent Document 1). In training for removing calculi, users of tooth models use calculus removal tools such as scalers to detect and remove model calculi.

### CITATION LIST

### Patent Document

Patent Document 1: Japanese Unexamined Patent Application, Publication No. 2007-41083

### DISCLOSURE OF THE INVENTION

### Problems to be Solved by the Invention

Here, although a model calculus of a small size can be easily removed with a calculus removal tool, it is difficult for a person who is not skilled to detect the model calculus. On the other hand, although a model calculus of a large size can be easily detected even by a novice, it is difficult to remove the model calculus with the calculus removal tool.

An object of the present invention is to provide a tooth model in which a model calculus is easy for even a novice to detect, and with which it is possible to practice removal using a calculus removal tool.

### Means for Solving the Problems

In order to achieve the above object, the present invention provides the following.

A tooth model including: a model tooth body; and a model calculus which is provided on a side surface of the model tooth body. The model calculus includes a large model calculus having a maximum width W1 satisfying 0.7 mm≤W1≤1.5 mm in a planar view seen from a side of the side surface, and having a boundary width W2 satisfying W2<W1, the boundary width W2 being a width at a boundary with the side surface of the model tooth body and in a same direction as a direction of the maximum width W1.

The large model calculus preferably has a spherical segment shape.

The boundary width W2 is preferably equal to or greater than 70% and equal to or less than 90% of the maximum width W1.

The model calculus may include a small model calculus having the maximum width WI satisfying 0.3 mm≤W1<0.7 mm, and the small model calculus may have the boundary width W2 satisfying W2≤W1.

The model calculus provided on the side surface of the model tooth body may include a plurality of model calculi, and the plurality of model calculi may form an aggregate of the plurality of model calculi arranged at intervals of equal to or less than 0.5 mm from each other.

The aggregate may include a plurality of aggregates, and an interval between the aggregates may be equal to or greater than 1 mm.

In a case where the model calculus has a thin and long shape, the maximum width W1 is preferably a maximum width in a minor axis direction,

### Effects of the Invention

According to the present invention, it is possible to provide a tooth model in which a model calculus is easy for even a novice to find, and with which it is possible to practice removal using a calculus removal tool.

### BRIEF DESCRIPTION OF THE DRAWINGS

FIG. 1 is an overall perspective view of a jaw model 1 including a tooth model 10 according to an embodiment;

FIG. 2 is a diagram of the tooth model 10 seen from outside of a mouth;

FIG. 3 is an enlarged view of a periphery A of a boundary portion between a tooth crown portion 11 and a tooth root portion 12, surrounded by the dotted line in FIG. 2;

FIG. 4 is a sectional view along the line B-B in FIG. 3 and illustrates a large model calculus 13B;

FIG. 5A is a diagram illustrating a small model calculus 13S and is a sectional view along the line C-C in FIG. 3;

FIG. 5B is a diagram illustrating the small model calculus 13S and is a sectional view along the line D-D in FIG. 3;

FIG. 6A is a diagram illustrating a model calculus 113 according to a modification and illustrates a large model calculus 113B or a small model calculus 113Sa satisfying W2<W1;

FIG. 6B is a diagram illustrating the model calculus 113 according to a modification and illustrates a small model calculus 113Sb satisfying W2=W1; and

FIG. 7 is a diagram illustrating a model calculus 213 according to a modification.

### PREFERRED MODE FOR CARRYING OUT THE INVENTION

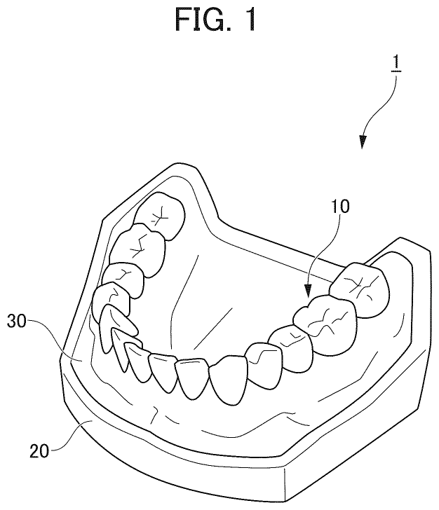

Hereinafter, an embodiment of the present invention will be described with reference to drawings. FIG. 1 is an overall perspective view of a jaw model 1 including a tooth model 10 according to an embodiment of the present invention. The jaw model 1 is used for dental training and includes the tooth model 10, a teeth base 20, and a model gum 30.

### Tooth Model 10

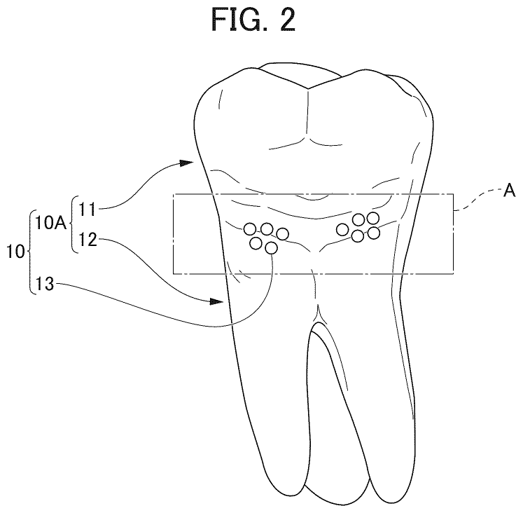

FIG. 2 is a diagram of the tooth model 10 seen from outside of a mouth. Although the tooth model 10 that imitates a molar will be described as the tooth model 10 in the embodiment, the tooth model 10 is not limited thereto and may imitate another tooth. The tooth model 10 includes a model tooth body 10A and a model calculus 13 provided on a side surface of the model tooth body 10A.

### Model Tooth Body 10A

The model tooth body 10A of the present embodiment has a shape that imitates an actual tooth and includes a tooth crown portion 11 and a tooth root portion 12. The tooth root portion 12 is inserted into an insertion hole portion which is formed along a row of teeth with respect to the teeth base 20 and is not illustrated in the drawing. The model tooth body 10A and the teeth base 20 are covered with the model gum 30 in a state where the tooth root portion 12 is inserted into the insertion hole portion, and the tooth model 10 is supported by the teeth base 20.

The model calculus 13 and the model tooth body 10A of the embodiment are integrally molded using an epoxy resin.

However, the model calculus 13 and the model tooth body 10A are not limited thereto and may be made of a different material as long as the different material can be used as a material of the tooth model 10.

Integral molding of the model calculus 13 and the model tooth body 10A as in the embodiment facilitates production of the tooth model 10 with a model calculus.

Also, repeated utilization of one molding die capable of integrally molding the model calculus 13 and the model tooth body 10A enables production of a large number of tooth models 10 having the same shape with small variations in adhesion form and adhesion force of the model calculi 13. It is possible to produce a large number of tooth models 10 with the same shape in this manner, and it is thus possible for a plurality of users to use the same tooth models 10 for the same training. Accordingly, the users are allowed to acquire substantially the same level of skills through the training. In addition, fairness can be ensured even in a case where others evaluate training achievements of the users.

### Model Calculus 13

The model calculus 13 is provided in a periphery A of a boundary portion between the tooth crown portion 11 and the tooth root portion 12 of the embodiment. Since the periphery of the boundary portion between the tooth crown portion 11 and the tooth root portion 12 is where calculi is actually likely to adhere, it is possible to create a state similar to an actual calculus adhesion state by providing the model calculus 13 in the periphery of the boundary portion. However, the model calculus 13 is not limited thereto and may be provided only to the tooth crown portion 11 or only to the tooth root portion 12.

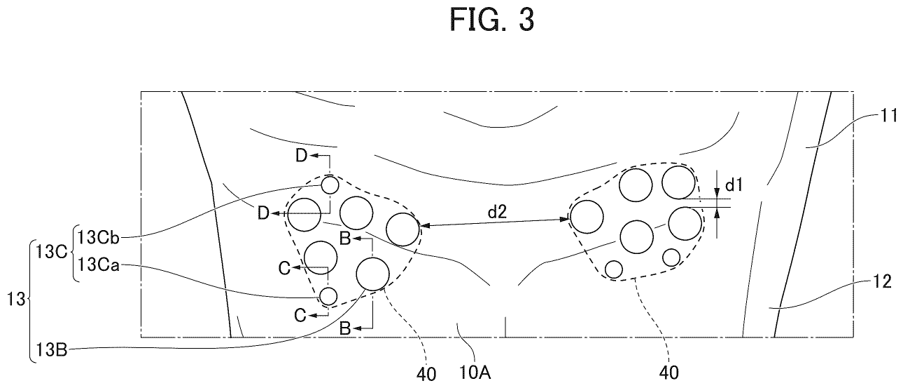

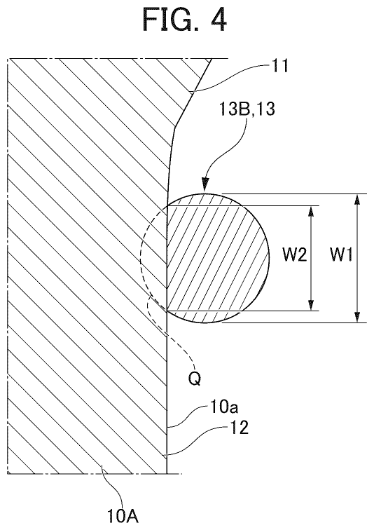

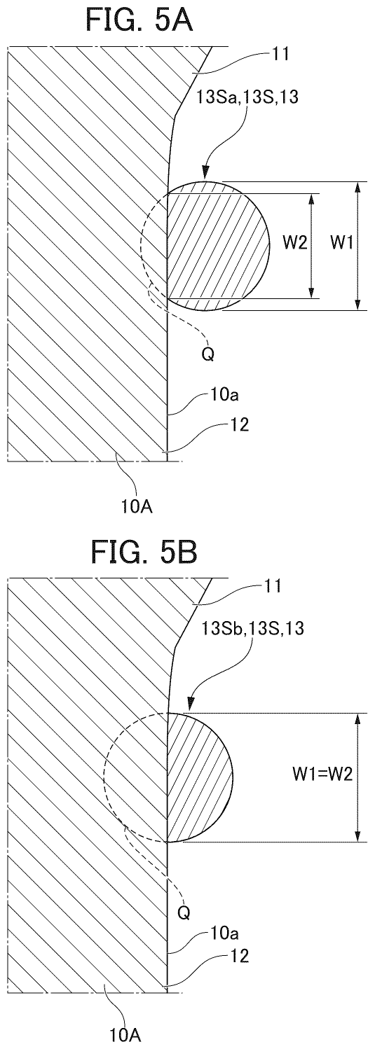

FIG. 3 is an enlarged view of the periphery A of the boundary portion between the tooth crown portion 11 and the tooth root portion 12, surrounded by the dash-dot line in FIG. 2. FIG. 4 is a sectional view along the line B-B in FIG. 3. FIG. 5A is a sectional view along the line C-C in FIG. 3. FIG. 5B is a sectional view along the line D-D in FIG. 3.

The model calculus 13 of the embodiment has a spherical segment shape obtained by cutting a virtual spherical body Q along one plane. In a planar view seen from a side of a side surface of the model tooth body 10A illustrated in FIGS. 4, 5A, and 5B, a maximum width W1 of the model calculus 13 satisfies 0.3 mm≤W1≤1.5 mm. In more detail, the model calculus 13 includes large model calculi 13B satisfying 0.7 mm≤W1≤1.5 mm and small model calculi 13S satisfying 0.3 mm≤W1<0.7 mm.

FIG. 4 is a diagram illustrating a large model calculus 13B satisfying 0.7 mm≤W1≤1.5 mm. The large model calculus 13B has, at the boundary with the side surface 10a of the model tooth body 10A, a boundary width W2 which is a width in the same direction as the direction of the maximum width W1, and the boundary width W2 satisfies W2<W1.

FIGS. 5A and 5B are diagrams illustrating small model calculi 13S satisfying 0.3 mm≤W1<0.7 mm. The small model calculi 13S include a small model calculus 13Sa illustrated in FIG. 5A and a small model calculus 13Sb illustrated in FIG. 5B. The small model calculus 13Sa has, at the boundary with the side surface 10a of the model tooth body 10A, a boundary width W2 which is the width in the same direction as the direction of the maximum width W1 and satisfies W2<W1. The small model calculus 13Sb satisfies W2=W1, that is, for the small model calculus 13Sb, the boundary width W2 is equal to the maximum width W1.

The large model calculus 13B illustrated in FIG. 4 and the small model calculus 13Sa illustrated in FIG. 5A have the boundary width W2 that satisfies W2<W1. In other words, the widths of the large model calculus 13B and the small model calculus 13Sa gradually increase up to the boundary width W2 from the boundary width W2 at the boundary portion with the side surface 10a of the model tooth body 10A toward the projecting side.

As described above, the model calculus 13 has a spherical segment shape obtained by cutting the virtual spherical body Q along a plane at the boundary with the side surface 10a of the model tooth body 10A in the embodiment. The maximum width W1 is the diameter of the virtual spherical body Q. The boundary width W2 is the diameter of the circular out surface of the virtual spherical body Q along the side surface 10a of the model tooth body 10A.

The projection heights of the large model calculus 13B and the small model calculus 13Sa from the side surface 10a of the model tooth body 10A are about 75% of the diameter of the virtual spherical body Q in the embodiment. About 75% of the diameter of the virtual spherical body Q is expressed as W2≈0.86W1 in terms of a relationship between the maximum width W1 and the boundary width W2. However, the boundary width W2 is not limited thereto and is preferably equal to or greater than 70% and equal to or less than 90% of the maximum width W1, and more preferably equal to or greater than 80% and equal to or less than 90% of the maximum width W1.

### Small Model Calculus 13Sb

The small model calculus 13Sb illustrated in FIG. 5B has the boundary width W2 that satisfies W2=W1. In other words, the small model calculus 13Sb has, at the boundary portion with the side surface 10a of the model tooth body 10A, the boundary width W2 which is the maximum width W1. In the embodiment, the projecting height of the small model calculus 13Sb, which is one of the model calculi 13, from the side surface 10a of the model tooth body 10A is about 50% of the diameter of the virtual spherical body Q. In other words, the maximum width W1 and the boundary width W2 are equal to the diameter of the virtual spherical body Q.

### Model Calculus Group 40

As illustrated in FIG. 3, a plurality of model calculi 13 are provided on the side surface of the model tooth body 10A. The plurality of model calculi 13 form a model calculus group 40 which is an aggregate of the model calculi 13 arranged at intervals d1 of equal to or less than 0.5 mm from each other. In a case where two or more model calculus groups 40 are formed, an interval d2 between the model calculus groups 40 is equal to or greater than 1 mm.

The tooth model 10 of the embodiment described above is used in training for removing calculi. Specifically, in a state where the tooth model 10 is supported by the teeth base 20, a user can operate a calculus removal tool such as a scaler so as to remove the model calculi 13 from the tooth model 10 in a scheme similar to actual calculus removal.

The model calculus 13 in the embodiment includes the large model calculus 13B that has the maximum width W1 satisfying 0.7 mm≤W1≤1.5 mm in a planar view seen from the side of the side surface 10b of the model tooth body 10A and has, at the boundary with the side surface 10b of the model tooth body 10A, the boundary width W2 which is the width in the same direction as the direction of the maximum width W1 and satisfies W2<W1.

Since the large model calculus 13B is of such a large size, even a novice can easily detect the large model calculus 13B.

In general, many calculus removal tools have arc-shaped distal ends, and a calculus adhering to a side surface of a tooth is removed by moving the calculus removal tool from the tooth root toward the tooth crown along the side surface of the tooth. Here, even in the case of the large model calculus 13B having the maximum width W1 satisfying 0.7 mm≤W1≤1.5 mm in a planar view seen from the side of the side surface of the model tooth body, if the boundary width W2, which is at the boundary with the side surface of the model tooth body and in the same direction as the direction of the maximum width W1, satisfies W2=W1 instead of W2<W1, unlike in the embodiment, the area of adhesion of the large model calculus to the model tooth body is large, the adhesion force is thus large, and it is difficult to remove the calculus with the calculus removal tool.

However, in the embodiment, although the large model calculus 13B satisfies 0.7 mm≤W1≤1.5 mm, the boundary width W2, which is at the boundary with the side surface 10b of the model tooth body 10A and in the same direction as the direction of the maximum width W1, satisfies W2<W1. Therefore, the area of adhesion of the large model calculus 13B to the model tooth body 10A is smaller than that in the case where W2=W1. This makes it easy to remove the model calculus 13 from the side surface 10a of the model tooth body 10A.

Furthermore, since the boundary width W2 is smaller than the maximum width W1, a recessed portion is formed between the side surface 10a of the model tooth body 10A and the model calculus 13, and the arc-shaped distal end of the calculus removal tool gets caught on the recessed portion, when the model calculus 13 is going to be removed. This makes it yet easier to remove the model calculus 13 from the side surface 10a of the model tooth body 10A.

It should be noted that the small model calculus 13S satisfying 0.3 mm≤W1<0.7 mm can be easily removed even when W2=W1. Therefore, the small model calculus 13S satisfying 0.3 mm≤W1<0.7 mm includes not only the small model calculus 13Sa satisfying W2<W1 but also the small model calculus 13Sb satisfying W2=W1 in the embodiment.

However, in this case, it is difficult for a novice to detect the small model calculus 13S due to its small size.

In the embodiment, the model calculi 13 form the model calculus groups 40 each of which is an aggregate of the plurality of model calculi 13 arranged at intervals d1 of equal to or less than 0.5 mm from each other. Each model calculus group 40 that is an aggregate of the model calculi 13 arranged at intervals d1 of equal to or less than 0.5 mm from each other in this manner is recognized as one calculus of a size greater than 1.5 mm. If a minimum width W1 of one model calculus 13 in a planar view is greater than 1.5 mm, it is difficult to remove the model calculus 13 even when the boundary width W2 thereof is smaller than the minimum width W1 in a planar view.

However, in the embodiment, it is each model calculus group 40, which is an aggregate of a plurality of model calculi 13 and has a size greater than 1.5 mm that is recognized as one calculus. Also, each model calculus 13 included in the model calculus group 40 can be removed. This enables utilization in training for removing large calculi.

In addition, in a case where the interval d2 between the model calculus groups 40 is equal to or greater than 1 mm, it is possible to recognize the model calculus groups 40 as separate calculi.

### Modifications

Although the model calculus 13 has a spherical segment shape obtained by cutting a spherical body along one plane in the embodiment described hitherto, the present invention is not limited thereto, and the model calculus 13 may have a different shape as long as W2<W1 is satisfied in a case of a large model calculus satisfying 0.7 mm≤W1≤1.5 mm and as long as W2≤W1 is satisfied in a case of a small model calculus satisfying 0.3 mm≤W1<0.7 mm.

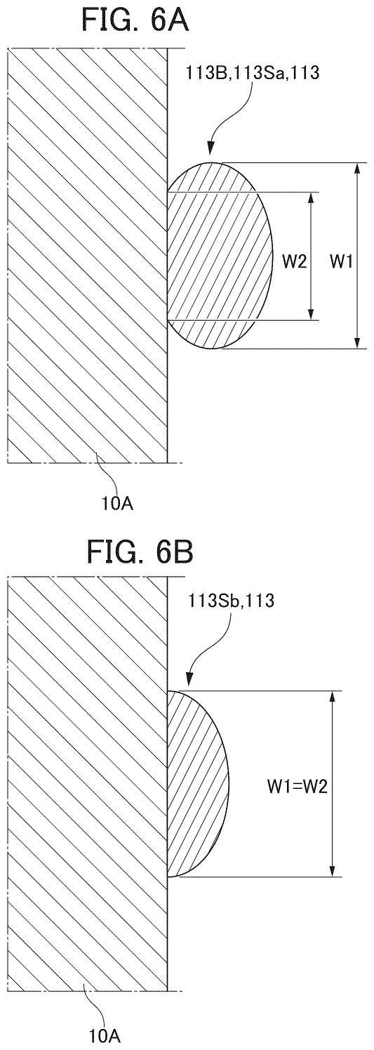

For example, FIGS. 6A and 6B are diagrams illustrating a model calculus 113 according to a modification. In the modification illustrated in FIGS. 6A and 6B, the model calculus 113 has an elliptical spherical segment shape obtained by cutting an elliptical spherical body along one plane. FIG. 6A illustrates a large model calculus 113B satisfying 0.7 mm≤W1≤1.5 mm or a small model calculus 113Sa satisfying 0.3 mm≤W1<0.7 mm and W2<W1. FIG. 6B illustrates a small model calculus 113Sb satisfying 0.3 mm≤W1<0.7 mm and W2=W1.

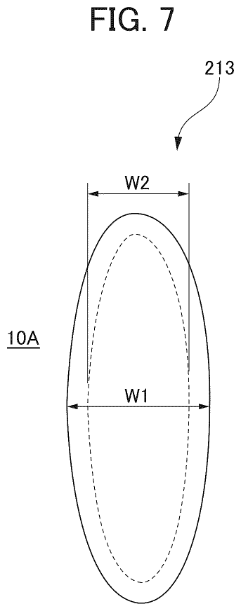

Moreover, FIG. 7 is a diagram illustrating a planar view of a large model calculus 213 according to a modification seen from the side of the side surface of the model tooth body 10A. The large model calculus 213 in FIG. 7 has a thin and long shape in a planar view.

In the case of such a thin and long shape, the large model calculus 213 has, in a planar view seen from the side of the side surface of the model tooth body 10A, a maximum width W1 that is the maximum width in a minor axis direction, and the maximum width W1 in the minor axis direction satisfies 0.7 mm≤W1≤1.5 mm.

Moreover, the large model calculus 213 has, at the boundary with the side surface of the model tooth body 10a, a boundary width W2 which is the width in the same direction as the direction of the maximum width W1 and satisfies W2<W1.

A recessed portion is also formed between the side surface 10a of the model tooth body 10A and the large model calculus 213 as in the case illustrated in FIG. 4, and the arc-shaped distal end of the calculus removal tool gets caught on the recessed portion. This makes it easy to remove the model calculus 213 from the side surface 10a of the model tooth body 10A on the minor axis side.

Furthermore, although the model tooth body 10 of the embodiment has a shape that imitates an actual tooth, the shape thereof is not limited thereto, and may be a plate shape or a columnar shape, for example.

### EXPLANATION OF REFERENCE NUMERALS

A: Periphery of boundary portion
Q: Virtual spherical body
W1: Maximum width
W2: Boundary width
1: Jaw model
10: Tooth model
10A: Model tooth body
10a: Side surface
11: Tooth crown portion
12: Tooth root portion
13: Model calculus
13B: Large model calculus
13Sa, 13Sb: Small model calculus

1. A tooth model comprising:
a model tooth body; and
model calculus provided on the side surface of the model tooth body, wherein
the model calculus includes
a large model calculus having a maximum width W1 satisfying 0.7 mm≤W1≤1.5 mm in a planar view seen from a side of the side surface, and having a boundary width W2 satisfying W2<W1, the boundary width W2 being a width at a boundary with the side surface of the model tooth body and in a same direction as a direction of the maximum width W1.

2. The tooth model according to claim 1, wherein
the large model calculus has a spherical segment shape.

3. The tooth model according to claim 1, wherein the boundary width W2 is equal to or greater than 70% and equal to or less than 90% of the maximum width W1.

4. The tooth model according to claim 1, wherein
the model calculus includes a small model calculus having the maximum width W1 satisfying 0.3 mm≤W1<0.7 mm, and
the small model calculus has the boundary width W2 satisfying W2≤W1.

5. The tooth model according to claim 1, wherein
the model calculus provided on the side surface of the model tooth body comprises a plurality of model calculi, and
the plurality of model calculi form an aggregate of the plurality of model calculi arranged at intervals of equal to or less than 0.5 mm from each other.

6. The tooth model according to claim 5, wherein
the aggregate comprises a plurality of aggregates, and
an interval between the aggregates is equal to or greater than 1 mm.

7. The tooth model according to claim 1, wherein
in a case where the model calculus has a thin and long shape, the maximum width W1 is a maximum width in a minor axis direction.
